(19) United States
(12) Patent Application Publication
(10) Pub. No.: US 2017/0286854 A1
(43) Pub. Date: Oct. 5, 2017

(54) AUTOMATIC REVISION OF A PREDICTIVE DAMAGE MODEL

(71) Applicant: General Electric Company, Schenectady, NY (US)

(72) Inventors: Paul Alex ARDIS, Niskayuna, NY (US); Yunwen XU, Niskayuna, NY (US)

(21) Appl. No.: 15/085,491

(22) Filed: Mar. 30, 2016

(51) Int. Cl. G06N 7/00; G06N 5/02

(52) U.S. Cl. CPC G06N 7/005; G06N 5/02

(57) ABSTRACT

A method for automatic revision of a predictive damage model that assess a physical system and provides maintenance recommendations to a user platform includes evaluating the predictive model at periodic intervals, identifying alternate parameters for the model that satisfy real-world physical constraints, determining an impact of the alternate parameters on an accuracy of the predictive model, forecasting performance of a predictive model modified with the alternate parameters, optimizing data driven terms of the predictive model by deploying the alternate parameters, and providing updated maintenance recommendations to a user platform display based on the modified predictive model. The method can also include comparing the one or more maintenance recommendations to actual maintenance experiences on the physical system, and also performing a heuristic parameter search for the data-driven terms. A non-transitory computer readable medium containing executable instructions and a system for implementing the method are also disclosed.

### BACKGROUND

Predictive analytic models can be based on data extracted from a product's historical performance. A predictive model can predict trends and behavior patterns to create maintenance schedules that both improve the product's field reliability and minimize its downtime. To predict a future event, a predictive model can be based on past occurrences, component reliability, and/or engineering predictions.

It can be desirable to make assessment and/or predictions regarding the operation of a real world physical system, such as an electro-mechanical system—e.g., an aircraft turbine engine. The predictive model can be used to predict a condition of the system, or a portion of the system, to help make maintenance decisions, budget predictions, etc. Even with improvements in sensor and computer technologies, however, accurately making such assessments and/or predictions can be a difficult task.

A predictive model can include parameters and dimensions of the real-world physical system, which can be updated by historical maintenance records and/or data from sensors embedded in the system itself. A robust predictive model can consider multiple components of a system, each having its own micro-characteristics and not just average measures of a plurality of components associated with a production run or lot. Moreover, it may be possible to very accurately monitor and continually assess the health of individual components, predict their remaining lives, and consequently estimate the health and remaining useful lives of systems that employ them.

### BRIEF DESCRIPTION OF THE DRAWINGS

FIG. 1 depicts a process for predictive performance improvement, in accordance with embodiments; and

FIG. 2 depicts a high-level architecture of an exemplary system, in accordance with embodiments.

### DETAILED DESCRIPTION

Embodying systems and methods provide automatic tracking of model performance and identification of alternate model parameters to improve the model's predictive performance utilizing available data. In accordance with embodiments, model performance is tracked via periodic model evaluation and comparison with actual performance records of the modeled devices (e.g., turbines, engines, etc.), where the performance records can include the actual condition of the model device(s) obtained by manual examination. One or more established model error metrics (such as Root Mean Squared Error) and secondary statistics thereof (such as delta value, percent delta value, angle of increase over multiple time periods, width of observed error readings, or crossing of discrete thresholds, etc.) are used to evaluate the model's predictive performance.

Embodying systems and methods can perform alternate parameter identification by implementing a search methodology using a search heuristic that yields parameters that monotonically decreases one or more established model error metrics (such as Root Mean Squared Error). The term “model” and/or “models” refers to distress or damage models for one or more physical assets (e.g., engine, turbine, engine assets, their components, and/or constituent parts).

Model performance is tracked by periodic evaluation on the latest set of data, computation of error metrics, comparison of metrics, and visualization of metrics. The performance of the model can additionally be forecasted via probabilistic tracking (e.g., auto regression, particle filtering). Evaluation of deterministic tracking can provide a predicted value and an error range. Probabilistic tracking can simulate a failure scenario multiple times to analyze the distribution of all simulation outcomes for a predictive range.

For example, turbine engines (e.g., aircraft engines) can have a high inlet temperature. Debris within the input airflow can deposit on the turbine blade, where the high temperature can cause particulate accumulation to build on the blades. The particulate deposit can include calcia, magnesia, alumina and silica (CMAS). The rate of CMAS accumulation can be modeled to predict when remedial maintenance action is needed to maintain the efficient, and safe operation of the turbine engine. The terms used by the predictive model are data-driven to optimize the model with physics-based constraints. When the model indicates maintenance and/or remedial action is needed, a system utilizing the model can send an alert message to a user platform for display to maintenance and operation crews.

Suggestions for the terms used as the model parameters are generated as the result of a parameter search using either global or local techniques. Global techniques can include Genetic Algorithms and Simulated Annealing while local can techniques include Gradient Descent and Local Beam Search.

In accordance with embodiments, autonomy and adaptation is added to existing prognostic models by tracking performance, diagnosing any degradation in the model performance, forecasting future model performance and retraining or retuning the model. Embodying approaches to model development and maintenance results in a time/cost reduction for validation of new models, a reduction in false alarms of failure prediction and missed detections for deployed, physical units being modeled. By tracking model performance over time (e.g., by comparison of predictive failures to actual, real-world experience), optimal model parameters can be suggested to improve performance at each incremental time step in the model.

Damage models with available parameter updates avoid loss of relevance and accuracy with changes in flight routes, introduction of new assets/carriers, adjustments in conditions at airports, and global condition changes (e.g., impact of climate change). This means that services built upon these damage models are capable and actionable from entry into service until asset termination regardless of duration, ensuring services backlog and revenue (without new model development) for the full duration of use.

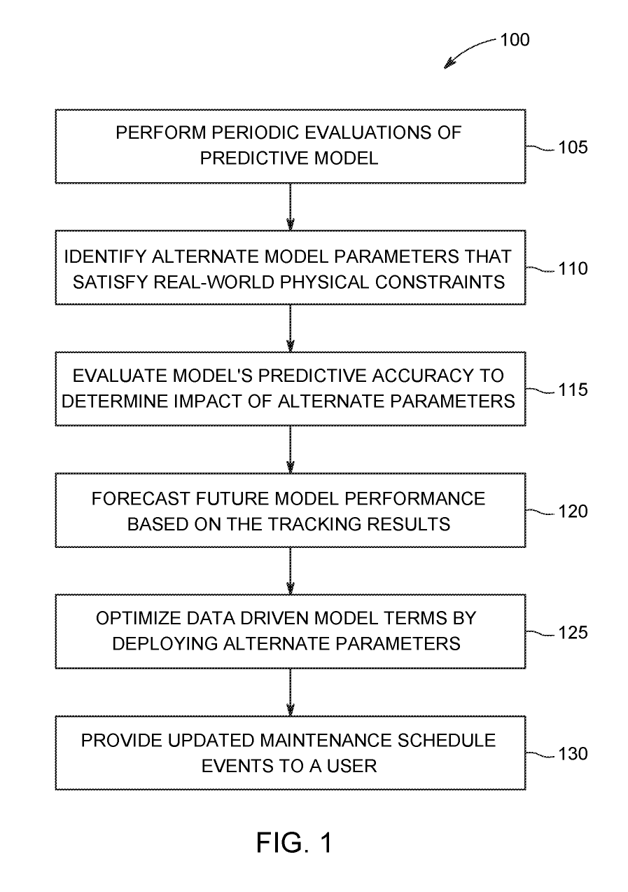

FIG. 1 depicts predictive performance improvement process 100 in accordance with embodiments. Process 100 tracks the performance of a predictive model by performing, step 105, periodic evaluations. The periodicity of these evaluations can be at predetermined regular intervals, or randomized in time. The evaluation can examine the latest data, error metrics, and/or compare the model predictions to real world recorded observations. Tracking can be done by deterministic and/or probabilistic methodologies. Where the deterministic methodology can provide a predicted value and an error range; and the probabilistic methodology can simulate a failure scenario multiple times and analyze the distribution of the simulation outcomes to determine a probabilistic range of likely results.

Alternate parameters that satisfy physical constraints can be identified, step 110, by implementing a heuristic search that yields parameters that monotonically decrease one or more error metrics. Global techniques for implementing the heuristic search can include, but are not limited to, genetic algorithms and simulated annealing. Local techniques for implementing the heuristic search can include, but are not limited to, gradient descent and local beam search.

The impact to model performance can be diagnosed, step 115, by evaluating performance (and any degradation) in the model's predictive accuracy after adaptation is made to the parameters in the model. By adapting the model and tracking the impact of the adaptation(s), several different parameterization sets can be exercised and evaluated. Conventional approaches rebuild the model, which can require coding and debugging, and then retraining of the new model.

Future model performance can be forecasted, step 120, by evaluating the parameterization set(s)' impact and selecting the set with the best performance (e.g., the lowest RMSE, or other metric). In accordance with embodiments, the system can perform a search over parameters to inform about the predictive performance so as to focus in on a new, modified/updated configuration (within constraints). This new, modified/updated configuration can optimize expected performance of the predictive model. Alternate parameter settings can be hypothesized, and evaluated using previously-seen real-world data on the physical system. The selection of parameters, and their related impact on future performance can be extrapolated from these hypothesized scenarios. By automatically performing process 100 model performance, development, and maintenance can be improved with a commensurate reduction in the associated costs and timeline as opposed to development, prove-out, and deployment of a new predictive model.

Data driven terms of the model are optimized, step 125, by deploying the newly identified parameters. The predictive model can update maintenance schedule event(s) by providing, step 130, an alert to a user of the updated schedule event.

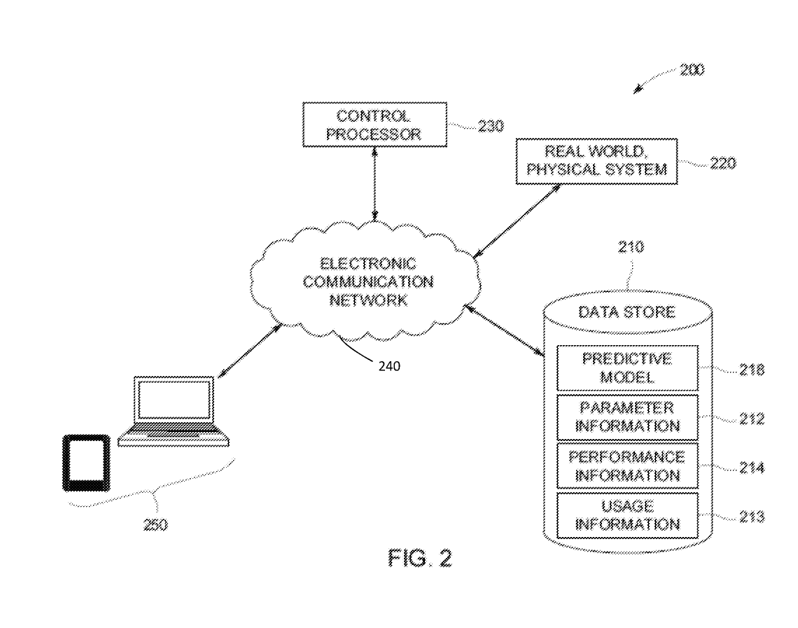

FIG. 2 is a high-level architecture of system 200 in accordance with some embodiments. System 200 includes a computer data store 210 that includes parameter information 212, and performance information 214 related to real-world physical system 220 (e.g., a turbine engine). Usage information 213 in the data store can include, for example, information historic engine sensor information, prior aircraft flights (e.g., external temperatures, exhaust gas temperatures, engine model numbers, takeoff and landing airports, etc.), existing maintenance scheduling, and engineering recommendations for servicing the physical system.

Predictive model 218 can be resident in the data store, and include instructions that can cause control processor 230 to create a prediction and/or result that may be transmitted to various user platforms 250 as appropriate (e.g., for display to a user). The components of system 200 can be located locally to each other, or remotely, or a combination thereof. Communication between the system components can be over an electronic communication network 240.

The electronic communication network can be an internal bus, or one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The prediction model, and system 200 itself, can store information into and/or retrieve information from various data sources, such as the computer data store 210 and/or user platforms 250. The various data sources may be locally stored or reside remote from system 200. A user may access system 200 via one of the user platforms 250 (e.g., a personal computer, tablet, smartphone, etc.).

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as automatic tracking of a model's performance and identification of alternate model parameters to improve the model's predictive performance utilizing available data, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A method for automatic revision of a predictive damage model, the method comprising:
evaluating the predictive model at periodic intervals, the predictive model configured to assess operation of a real-world physical system and to provide one or more maintenance recommendations to a user platform for display to a user;
identifying alternate parameters for the model, the alternate parameters satisfying real-world physical constraints;
determining an impact of the alternate parameters on an accuracy of the predictive model;
forecasting performance of a predictive model modified with the alternate parameters;
optimizing data driven terms of the predictive model by deploying the alternate parameters; and
providing updated maintenance recommendations to a user platform display based on the modified predictive model.

2. The method of claim 1, the evaluating step including tracking the performance of the predictive model over time.

3. The method of claim 2, the tracking including comparing the one or more maintenance recommendations to an actual maintenance experience on the physical system.

4. The method of claim 2, the tracking including at least one of deterministic tracking and probabilistic tracking.

5. The method of claim 4, the deterministic tracking including providing at least one of a predicted value and an error range.

6. The method of claim 4, the probabilistic tracking including:
simulating a failure scenario multiple times; and
analyzing a distribution of simulation outcomes to determine a probabilistic range of results.

7. The method of claim 1, including:
identifying the alternate parameters by performing a heuristic parameter search; and
generating the data-driven terms from results of the heuristic parameter search.

8. The method of claim 7, the heuristic parameter search including at least one of a global search technique and a local search technique.

9. The method of claim 8, the global search technique includes genetic algorithms and simulated annealing, and the local search techniques include gradient descent and local beam search.

10. The method of claim 1, the forecasting performance step including diagnosing any degradation in the future performance of the predictive model accuracy.

11. The method of claim 1, including retuning the predictive model with an updated set of alternate parameters.

12. A non-transitory computer readable medium containing computer-readable instructions stored therein for causing a computer processor to perform automatic revision of a predictive damage model comprising:
evaluating the predictive model at periodic intervals, the predictive model configured to assess operation of a real-world physical system and to provide one or more maintenance recommendations to a user platform for display to a user;
identifying alternate parameters for the model, the alternate parameters satisfying real-world physical constraints;
determining an impact of the alternate parameters on an accuracy of the predictive model;
forecasting performance of a predictive model modified with the alternate parameters;
optimizing data driven terms of the predictive model by deploying the alternate parameters; and
providing updated maintenance recommendations to a user platform display based on the modified predictive model.

13. The non-transitory computer-readable medium of claim 12, including instructions to cause the processor to perform the evaluating step by including tracking the performance of the predictive model over time.

14. The non-transitory computer-readable medium of claim 13, including instructions to cause the processor to perform the tracking by including comparing the one or more maintenance recommendations to an actual maintenance experience on the physical system.

15. The non-transitory computer-readable medium of claim 14, including instructions to cause the processor to perform the tracking by including at least one of deterministic tracking and probabilistic tracking.

16. The non-transitory computer-readable medium of claim 15 including instructions to cause the processor to perform the deterministic tracking by providing at least one of a predicted value and an error range.

17. The non-transitory computer-readable medium of claim 15 including instructions to cause the processor to perform the probabilistic tracking by:
simulating a failure scenario multiple times; and
analyzing a distribution of simulation outcomes to determine a probabilistic range of results.

18. The non-transitory computer-readable medium of claim 12, including instructions to cause the processor to perform the step of identifying the alternate parameters by performing a heuristic parameter search; and
including instructions to cause the processor to generate the data-driven terms from results of the heuristic parameter search.

19. The non-transitory computer-readable medium of claim 12, including instructions to cause the processor to perform the forecasting performance step by including diagnosing any degradation in the future performance of the predictive model accuracy.

20. The non-transitory computer-readable medium of claim 12, including instructions to cause the processor to perform a step of retuning the predictive model with an updated set of alternate parameters.
